(19) United States
(12) Patent Application Publication
(10) Pub. No.: US 2026/0086347 A1
(43) Pub. Date: Mar. 26, 2026

(54) DRIVING APPARATUS FOR OPTICAL DEFLECTOR, DRIVING METHOD FOR OPTICAL DEFLECTOR, OPTICAL SCANNING APPARATUS

(71) Applicant: STANLEY ELECTRIC CO., LTD., Tokyo (JP)

(72) Inventors: Naoto UMEHARA, Tokyo (JP); Kenji SUINA, Tokyo (JP)

(73) Assignee: STANLEY ELECTRIC CO., LTD., Tokyo (JP)

(21) Appl. No.: 19/328,276

(22) Filed: Sep. 15, 2025

(30) Foreign Application Priority Data
Sep. 20, 2024 (JP) 2024-164205

(51) Int. Cl. G02B 26/08; G02B 26/10

(52) U.S. Cl. CPC G02B 26/0816; G02B 26/101

(57) ABSTRACT

A driving apparatus for an optical deflector having a mirror, the apparatus including: a controller for controlling the operation of the mirror; a driver that outputs to the optical deflector a first drive signal for resonantly driving the mirror about a first axis and a second drive signal for non-resonantly driving the mirror about a second axis based on data output from the controller; and a sensor processing unit connected to the controller for acquiring a sensor signal output from the mirror; where the controller calculates a phase difference between the first drive signal and the sensor signal, determines that the operation of the optical deflector is normal when the calculated phase difference relative to the phase of the second drive signal is within a predetermined fixed range and determines that the operation of the optical deflector is abnormal when the calculated phase difference is not within the fixed range.

### CROSS-REFERENCE TO RELATED APPLICATION

The present application is based on, and claims priority from, JP Application Serial Number, 2024-164205 filed on Sep. 20, 2024, the disclosure of which is hereby incorporated by reference herein in its entirety.

### BACKGROUND

### Technical Field

The present disclosure relates to a driving apparatus for an optical deflector, a driving method for an optical deflector, and an optical scanning apparatus.

### Description of the Background Art

Japanese Laid-Open Patent Publication No. 2021-117273 describes a lighting apparatus configured in a control device that includes a control unit that generates a resonant drive signal which resonates and drives the mirror of an optical deflector and a non-resonant drive signal that drives the mirror non-resonantly, a resonant sensor that detects the resonant drive of the mirror and generates a resonant sensor signal, and a signal processing unit that acquires the phase difference between the resonant drive signal generated by the control unit and the resonant sensor signal when the mirror is resonantly and non-resonantly driven to scan, and that determines (i.e., detect operational abnormalities) whether or not the amplitude of the non-resonant drive signal is normal based on the phase difference.

In a specific aspect, it is an object of the present disclosure to provide a technology that enables detection of operational abnormalities in an optical deflector with greater precision.

### SUMMARY

(1) A driving apparatus for an optical deflector according to one aspect of the present disclosure is an apparatus that drives an optical deflector having a mirror which rotates about each of a first axis and a second axis, the apparatus including:
   a controller for controlling the operation of the mirror;
   a driver connected to the controller that outputs to the optical deflector a first drive signal for resonantly driving the mirror about the first axis and a second drive signal for non-resonantly driving the mirror about the second axis based on data output from the controller; and
   a sensor processing unit connected to the controller for acquiring a sensor signal output from the mirror;
where the controller calculates a phase difference between the first drive signal and the sensor signal, and in a situation where the phase difference is calculated, determines that the operation of the optical deflector is normal when the phase difference relative to the phase of the second drive signal is within a predetermined fixed range, and determines that the operation of the optical deflector is abnormal when the phase difference is not within the fixed range.
(2) A driving method for an optical deflector according to one aspect of the present disclosure is a driving method for an optical deflector having a mirror which rotates about each of a first axis and a second axis, the method including:
   applying to the mirror a first drive signal for resonantly driving the mirror about the first axis and a second drive signal for non-resonantly driving the mirror about the second axis;
   acquiring a sensor signal output from the mirror;
   calculating a phase difference between the first drive signal and the sensor signal, and in a situation where the phase difference is calculated, determining that the operation of the optical deflector is normal when the phase difference relative to the phase of the second drive signal is within a predetermined fixed range, and determining that the operation of the optical deflector is abnormal when the phase difference is not within the fixed range.

An optical scanning apparatus according to one aspect of the present disclosure is an optical scanning apparatus including:
the driving apparatus according to the above-described (1); and
an optical deflector connected to the driving apparatus.

According to the above configurations, a technology is provided that enables detection of operational abnormalities in an optical deflector with greater precision.

### BRIEF DESCRIPTION OF THE DRAWINGS

FIG. 1 is a diagram showing a schematic configuration of an optical scanning apparatus according to one embodiment.

FIG. 2 is a schematic diagram showing a configuration example of an optical deflector.

FIG. 3 is a diagram illustrating the timing for acquiring the phase difference.

FIG. 4A through FIG. 4D are diagrams explaining the principle for determining whether or not an operational abnormality exists.

FIG. 5A is a diagram illustrating an example of the fixed range.

FIG. 5B is a diagram illustrating another example of the fixed range.

FIG. 6 is a flowchart showing the operating procedure of the controller in the driving apparatus.

### DESCRIPTION OF THE PREFERRED EMBODIMENTS

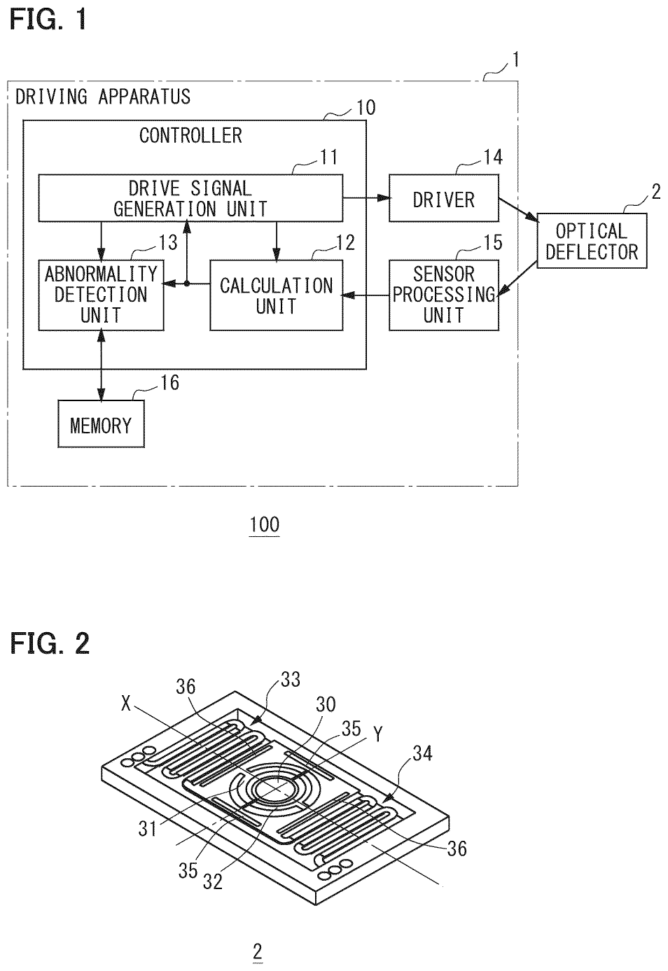

FIG. 1 is a diagram showing a schematic configuration of an optical scanning apparatus according to one embodiment. Optical scanning apparatus 100 of the present embodiment is used to scan light such as laser light which is incident from a light source or the like, and is configured to include a driving apparatus 1 and an optical deflector 2. Driving apparatus 1 is connected to optical deflector 2 and controls the operation of optical deflector 2. Optical deflector 2 has a rotatable mirror, and by irradiating light such as laser light onto this mirror, the reflection direction of the light can be freely changed. For example, optical scanning device 100 according to the present embodiment can be used to configure an image projection apparatus (projector) that forms an image on a screen by scanning laser light incident from a light source (not shown) in two directions (H direction and V direction).

Driving apparatus 1 is configured to include a controller 10, a driver 14, a sensor processing unit 15, and a memory 16. Controller 10 controls the overall operation of driving apparatus 1 and comprises a drive signal generation unit 11, a calculation unit 12, and an abnormality detection unit 13 as functional blocks. Each functional block in controller 10 can be realized by running a specified program on a microcomputer, for example.

Drive signal generation unit 11 generates data (drive data) for generating a drive signal and supplies the drive data to driver 14. The drive data includes at least data for generating horizontal drive signals and vertical drive signals, and hereinafter, these will be referred to as “horizontal drive data” and “vertical drive data”, respectively.

Calculation unit 12 acquires horizontal drive data from drive signal generation unit 11 and digital data of the sensor signal (hereinafter referred to as “sensor data”) output from sensor processing unit 15 and uses these to calculate the phase difference between the horizontal drive signal and the sensor signal.

Abnormality detection unit 13 acquires data indicating the amplitude and phase of the vertical drive signal from drive signal generation unit 11, and acquires data indicating the phase difference between the horizontal drive signal and the sensor signal from calculation unit 12. And based on these amplitude, phase, and phase difference, abnormality detection unit 13 determines whether or not there is an operational abnormality in optical deflector 2. The data indicating the presence or absence of operational abnormality is stored in memory 16.

Driver 14 primarily generates horizontal drive signals and vertical drive signals by performing digital-to-analog conversion on the horizontal drive data and vertical drive data output from drive signal generation unit 11 and by performing processes such as amplifying the data to the drive voltage level of optical deflector 2. Then, driver 14 outputs these signals to optical deflector 2.

Sensor processing unit 15 converts the sensor signal output from optical deflector 2 into digital sensor data, primarily by amplifying it to a voltage level appropriate for analog-to-digital conversion and then performing analog-to-digital conversion. The digital sensor data is output to calculation unit 12 of controller 10.

Memory 16 stores data indicating the determination result made by abnormality detection unit 13 as to whether or not there exists an operational abnormality. Further, memory 16 can store data necessary for abnormality detection unit 13 to determine whether or not an abnormality has occurred.

FIG. 2 is a schematic diagram showing a configuration example of an optical deflector. As main components, the illustrated optical deflector 2 is configured to include a mirror 30, first actuators 31 and 32, second actuators 33 and 34, and sensors 35 and 36. Mirror 30 has a reflective surface for reflecting incident light and is configured to be rotatable around two axes, the X and Y axes shown in the figure. First actuators 31 and 32 generate a driving force for rotating mirror 30 around the Y axis. Second actuators 33 and 34 generate a driving force for rotating mirror 30 around the X axis. First actuators 31 and 32 and second actuators 33 and 34 can each be a piezoelectric, electrostatic, or electromagnetic actuator, for example. The displacement amounts of first actuators 31 and 32 and second actuators 33 and 34 are detected by sensors 35 and 36, respectively.

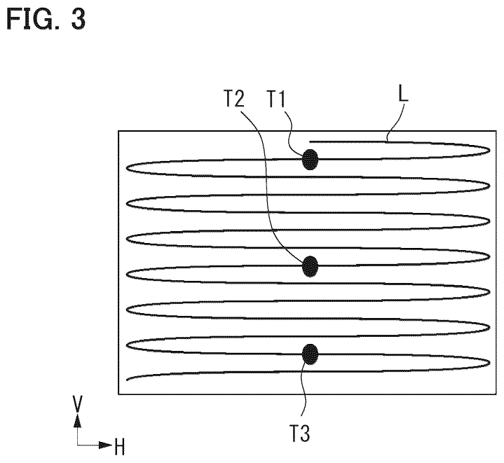

FIG. 3 is a diagram illustrating the timing for acquiring the phase difference. Here, a trajectory L is schematically shown when light is scanned on the screen. The up-down direction in the diagram corresponds to the V direction, and the left-right direction corresponds to the H direction. In the example shown in the figure, within one cycle of the scanning period in the V direction, phase differences are acquired at three time points: at time point T1 near the start of the scanning period, at time point T2 in the middle of the scanning period, and at time point T3 near the end of the scanning period. Here, note that this is merely an example, and the number of phase differences to be acquired within one cycle of the scanning period may be increased or decreased.

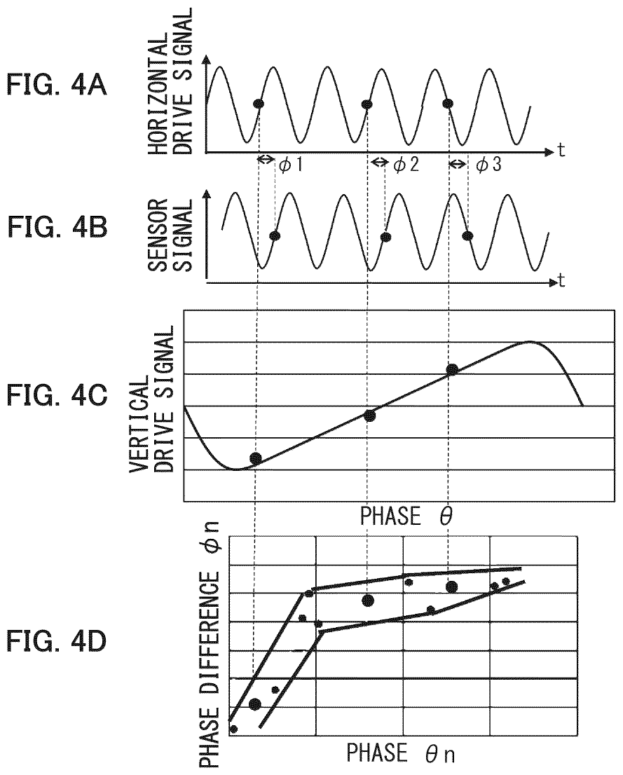

FIG. 4A through FIG. 4D are diagrams explaining the principles for determining whether or not an operational abnormality exists. In detail, from top to bottom, FIG. 4A is a waveform diagram of the horizontal drive signal, FIG. 4B is a waveform diagram of the sensor signal, FIG. 4C is a diagram showing the correspondence between phase θ and the vertical drive signal, and FIG. 4D is a diagram showing the correspondence between phase θn and phase difference Φn. The relative relationship in terms of time points among these figures are indicated using dotted lines in a format similar to a timing chart.

The horizontal drive signal shown in FIG. 4A is a sine wave signal at a specified cycle. When optical deflector 2 is operated by this horizontal drive signal, as shown in FIG. 4B, the sensor signal becomes a sine wave signal with approximately the same cycle as the horizontal drive signal. The three black dots on the waveform in FIG. 4A represent time points T1 to T3 shown in FIG. 3 described above. As can be seen from comparing FIG. 4A and FIG. 4B, phase difference occurs between the horizontal drive signal and the sensor signal. The phase differences Φn at time points T1, T2, and T3 are defined as Φ1, Φ2, and Φ3, respectively.

As shown in FIG. 4C, the relationship between the amplitude, which is the magnitude of the vertical drive signal, and phase θn is not constant in each time point T1 to T3. Thus, as shown in FIG. 4D, it can be seen that phase difference Φn can vary not only due to the amplitude A of the vertical drive signal but also due to phase θn of the vertical drive signal. When optical deflector 2 is driven, the tilt of the vertical drive is usually controlled linearly, however, the rigidity of the horizontal resonant movement around mirror 30 during this process changes depending on the tilt of the vertical drive.

Therefore, as shown in FIG. 4D, when phase difference Φn relative to phase θn is within a predetermined fixed range, it can be determined that there is no operational abnormality, and when it is outside the fixed range, it can be determined that there exists an operational abnormality. This fixed range can be determined in advance by experimentation, simulation, or other methods, for example.

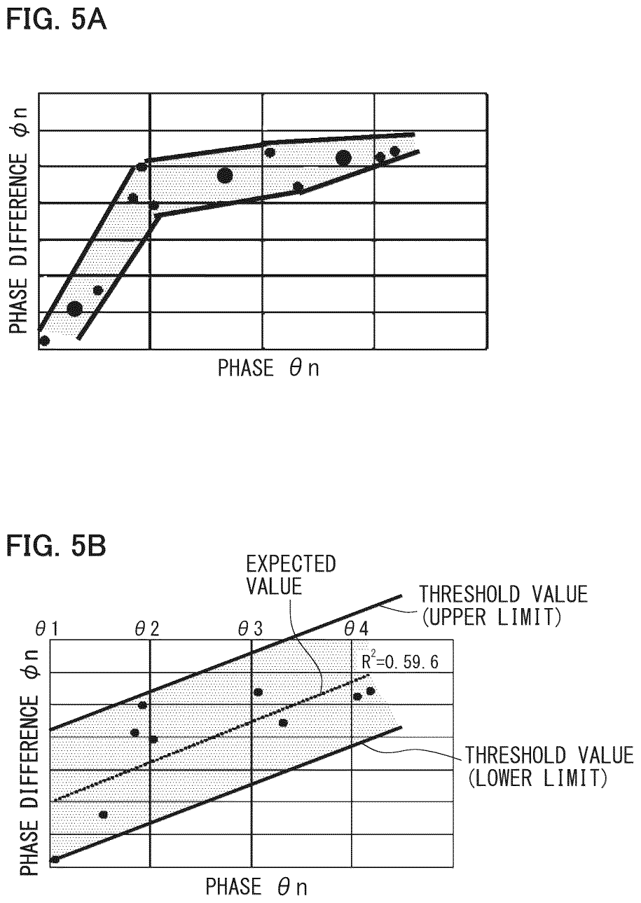

FIG. 5A is a diagram illustrating an example of the fixed range. In the figure, the range between the upper and lower limits drawn with bold lines (the range provided with a pattern in the figure) can be defined as the fixed range. In this case, the upper and lower limits are determined in advance based on experiments or simulations, for example. Alternatively, as shown in FIG. 5B, the fixed range can be determined by calculating an approximate line or curve based on multiple data sets of phases θn and phase differences Φn obtained in advance through experiments, etc., then determine the upper limit and lower limit of the threshold value by changing the intercept based on this approximation curve, etc., and then define the range between these upper and lower limits (the range provided with a pattern in the figure) as the fixed range. Data for determining the fixed range is pre-stored in memory 16 and is read by abnormality detection unit 13 for use in the determination.

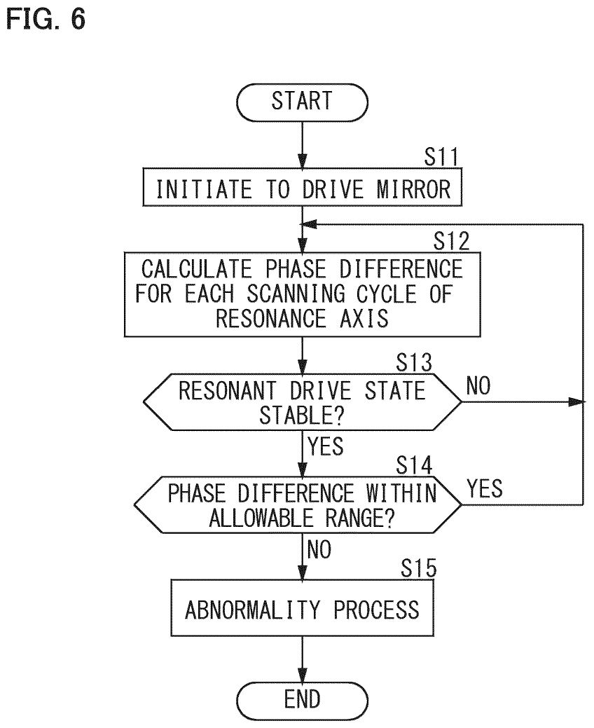

FIG. 6 is a flowchart showing the operating procedure of the controller in the driving apparatus. Here, note that the order of the processes shown may be changed as long as no contradictions or inconsistencies occur in the results of the information processing, and other processes not explicitly shown here may also be added.

Controller 10 initiates to drive mirror 30 of optical deflector 2 (step S11). Specifically, horizontal drive data and vertical drive data are generated by drive signal generation unit 11 and input to driver 14. Based on these data, horizontal drive signals and vertical drive signals are input from driver 14 to optical deflector 2, thereby driving mirror 30. Here, while mirror 30 is being resonantly driven in the main scanning direction (Y-axis direction), non-resonant driving in the sub-scanning direction (X-axis direction) is further initiated.

Calculation unit 12 of controller 10 calculates the phase difference for each scanning cycle of the Y-axis, which is the resonance axis (Step S12). Specifically, calculation unit 12 calculates the phase difference based on the digital data of the sensor signal input from sensor processing unit 15 and the horizontal drive data (digital data of the horizontal drive signal) input from drive signal generation unit 11.

Next, calculation unit 12 of controller 10 determines whether or not the resonant drive state is stable (step S13). Specifically, calculation unit 12 determines whether or not the resonant drive state is stable based on the changes in amplitude and the elapsed time of the sensor signal acquired by calculation unit 12. When the resonant drive state is not stable (step S13; NO), the process returns to step S12.

When the resonant drive state is stable (step S13; YES), abnormality detection unit 13 determines whether or not the phase difference calculated in step S12 falls within a fixed range set based on the amplitude and phase of the vertical drive signal, i.e., whether it is within the allowable range. When it is within the allowable range (step S14; YES), abnormality detection unit 13 stores data indicating the operational abnormality “to be not present” (normal) in memory 16. Then, the process returns to step S12, and the subsequent processes are repeated.

When the phase difference is not within the allowable range (Step S14: NO), abnormality detection unit 13 executes a predetermined abnormality process (Step S15). Specifically, abnormality detection unit 13 stores data indicating an operational abnormality “to be present” (abnormal) in memory 16. Further, abnormality detection unit 13 may output a signal or data which indicates an operational abnormality to a higher level device (not shown), or may instruct drive signal generation unit 11 to stop driving the optical deflector.

According to the above-described embodiment, it is possible to detect operational abnormalities in an optical deflector with greater precision.

Here, note that the present disclosure is not limited to the above-described embodiment, and various modifications can be made within the scope of the gist of the present disclosure. For example, the specific structure of the optical deflector to be controlled is not limited to the example illustrated in the above-described FIG. 2.

Further, the above-described fixed range may be calculated each time from fluctuations in the amplitude and phase of the vertical drive signal. In detail, for example, data indicating the relationship between the amplitude and phase for each phase period of the vertical drive signal (e.g., the period between θ1 and θ2, the period between θ2 and θ3, and the period between θ3 and θ4 shown in the figure) may be obtained, and linear approximation or the like may be performed based on these data (refer to FIG. 5B). Then, the fixed range may be determined by setting upper and lower threshold limits within a range of ±10% based on the obtained approximation, for example. In this case, it is sufficient to provided only one step for determining the fixed range between steps S13 and S14 in the flowchart described above (refer to FIG. 6).

### DESCRIPTION OF SYMBOLS

1: Driving apparatus
2: Optical deflector
10: Controller
11: Drive signal generation unit
12: Calculation unit
13: Abnormality detection unit
14: Driver
15: Sensor processing unit
16: Memory

What is claimed is:

1. A driving apparatus for an optical deflector that drives the optical deflector having a mirror which rotates about each of a first axis and a second axis, the apparatus comprising:
a controller for controlling the operation of the mirror;
a driver connected to the controller that outputs to the optical deflector a first drive signal for resonantly driving the mirror about the first axis and a second drive signal for non-resonantly driving the mirror about the second axis based on data output from the controller; and
a sensor processing unit connected to the controller for acquiring a sensor signal output from the mirror;
wherein the controller calculates a phase difference between the first drive signal and the sensor signal, and in a situation where the phase difference is calculated, determines that the operation of the optical deflector is normal when the phase difference relative to the phase of the second drive signal is within a predetermined fixed range, and determines that the operation of the optical deflector is abnormal when the phase difference is not within the fixed range.

2. The driving apparatus for an optical deflector according to claim 1 further comprising a memory connected to the controller and storing in advance a determination data capable of determining the fixed range;
wherein the controller determines the fixed range by reading the determination data from the memory.

3. The driving apparatus for an optical deflector according to claim 2,
wherein the controller writes a determination result data which indicates whether the operation of the optical deflector is normal or abnormal into the memory.

4. The driving apparatus for an optical deflector according to claim 1,
wherein the first drive signal is a horizontal drive signal and the second drive signal is a vertical drive signal.

5. The driving apparatus for an optical deflector according to claim 1,
wherein the controller determines whether the operation of the optical deflector is normal or abnormal when the resonant drive state of the optical deflector is stable.

6. A driving method for an optical deflector having a mirror which rotates about each of a first axis and a second axis, the method comprising:
applying to the mirror a first drive signal for resonantly driving the mirror about the first axis and a second drive signal for non-resonantly driving the mirror about the second axis;
acquiring a sensor signal output from the mirror;
calculating a phase difference between the first drive signal and the sensor signal, and in a situation where the phase difference is calculated, determining that the operation of the optical deflector is normal when the phase difference relative to the phase of the second drive signal is within a predetermined fixed range, and determining that the operation of the optical deflector is abnormal when the phase difference is not within the fixed range.

7. An optical scanning apparatus comprising:
the driving apparatus according to claim 1; and
an optical deflector connected to the driving apparatus.
